(19) United States
(12) Patent Application Publication
(10) Pub. No.: US 2011/0304901 A1
(43) Pub. Date: Dec. 15, 2011

(54) WINDOW AND MULTIPLE-GLAZED WINDOW

(76) Inventors: Mi-Hyun Lee, Yongin-si (KR); Myun-Gi Shim, Yongin-si (KR); Dong-Gun Moon, Yongin-si (KR); Soo-Ho Park, Yongin-si (KR); Tae-Hyun Bae, Yongin-si (KR)

(21) Appl. No.: 12/985,231

(22) Filed: Jan. 5, 2011

(30) Foreign Application Priority Data
Jun. 10, 2010 (KR) 10-2010-0055106

(51) Int. Cl. G02F 1/01

(52) U.S. Cl. 359/288

(57) ABSTRACT

A window including a frame and a panel. The panel includes a transparent substrate, a far infrared ray emitting layer deposited on the transparent substrate, and a thermochromic layer deposited on the transparent substrate and arranged to be closer than the far infrared ray emitting layer to an outdoor space.

### CROSS-REFERENCE TO RELATED APPLICATION

This application claims priority to and the benefit of Korean Patent Application No. 10-2010-0055106, filed on Jun. 10, 2010, in the Korean Intellectual Property Office, the entire content of which is incorporated herein by reference.

### BACKGROUND

1. Field

One or more embodiments of the present invention relate to a window and a multiple-glazed window including a thermochromic layer and far infrared ray emitting layer.

2. Description of the Related Art

With the soaring of the price of chemical energy sources such as petroleum, the demand for the development of a new energy source has increased. Also, the control of energy consumption is important as well. Actually, over 60% of the amount of energy consumption in a typical household is used for air conditioning. Also, the amount of energy lost through windows in a typical household or building amounts to about 24%.

As such, various efforts have been made to save the energy lost through windows. The efforts to save energy include a method of adjusting the size of a window and a method of using a highly insulated window.

### SUMMARY

One or more aspects of embodiments of the present invention are directed toward a window, e.g., a multiple-glazed window including a thermochromic layer and far infrared ray emitting layer, that efficiently save energy.

Additional aspects will be set forth in part in the description which follows and, in part, will be apparent from the description, or may be learned by practice of the presented embodiments.

According to one or more embodiments of the present invention, a window includes: a transparent substrate; a far infrared ray emitting layer deposited on the transparent substrate; and a thermochromic layer deposited on the transparent substrate and arranged to be closer than the far infrared ray emitting layer to an outdoor space.

In one embodiment, the thermochromic layer includes vanadium oxide. In one embodiment, the vanadium oxide has a stoichiometric ratio of about 1:2 or about 2:5 between vanadium atoms and oxygen atoms. In one embodiment, the thermochromic layer includes a material selected from the group consisting of fluorine (F), titanium (Ti), niobium (Nb), molybdenum (Mo), iridium (Ir), and tungsten (W).

In one embodiment, the far infrared ray emitting layer includes a far infrared ray emitting material and an insulation material. In one embodiment, the far infrared ray emitting layer includes the far infrared ray emitting material and the insulation material at 10-30 wt % and 70-90 wt %, respectively. In one embodiment, the far infrared ray emitting material includes ceramic powder. In one embodiment, the insulation material includes a material selected from the group consisting of dimethyl terephthalate, ethylene glycol, polytrimethylene terephthalate base, polycarbonate base, and polyurethane.

In one embodiment, the far infrared ray emitting layer is arranged to be closer than the thermochromic layer to an indoor space.

In one embodiment, the far infrared ray emitting layer is configured to emit far infrared rays in proportion to the quantity of near infrared rays passing through the thermochromic layer.

According to one or more embodiments of the present invention, a multiple-glazed window includes a frame, a first panel, and a second panel. The first panel includes: a first transparent substrate; a far infrared ray emitting layer deposited on the first transparent substrate; and a thermochromic layer deposited on the first transparent substrate and arranged to be closer than the far infrared ray emitting layer to an outdoor space, wherein the second panel includes a second transparent substrate.

In one embodiment, the thermochromic layer includes vanadium oxide. In one embodiment, the vanadium oxide has a stoichiometric ratio of about 1:2 or about 2:5 between vanadium atoms and oxygen atoms. In one embodiment, the thermochromic layer includes a material selected from the group consisting of fluorine (F), titanium (Ti), niobium (Nb), molybdenum (Mo), iridium (Ir), and tungsten (W).

In one embodiment, the far infrared ray emitting layer includes a far infrared ray emitting material and an insulation material. In one embodiment, the far infrared ray emitting layer includes the far infrared ray emitting material and the insulation material at 10-30 wt % and 70-90 wt %, respectively. In one embodiment, the far infrared ray emitting material includes ceramic powder. In one embodiment, the insulation material includes a material selected from the group consisting of dimethyl terephthalate, ethylene glycol, polytrimethylene terephthalate base, polycarbonate base, and polyurethane.

In one embodiment, the far infrared ray emitting layer is arranged to be closer than the thermochromic layer to an indoor space.

In one embodiment, the second panel is arranged to be closer than the thermochromic layer to the outdoor space and a space is provided between the first panel and the second panel.

In one embodiment, the far infrared ray emitting layer is configured to emit far infrared rays in proportion to the quantity of near infrared rays passing through the thermochromic layer.

### BRIEF DESCRIPTION OF THE DRAWINGS

These and/or other aspects will become apparent and more readily appreciated from the following description of the embodiments, taken in conjunction with the accompanying drawings of which:

FIG. 1 illustrates a window according to an embodiment of the present invention;

FIG. 2 is a graph showing an infrared ray transmissivity rate of vanadium oxide;

FIGS. 3A and 3B illustrate the operation of the panel of FIG. 1;

FIG. 4 illustrates a multiple-glazed window according to an embodiment of the present invention; and

FIGS. 5A and 5B illustrate the operation of panels of FIG. 4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The terms such as “first” and “second” are used herein merely to describe a variety of constituent elements, but the constituent elements are not limited by the terms. The terms are used only for the purpose of distinguishing one constituent element from another constituent element.

The terms used in the present specification are used for explaining a specific exemplary embodiment, not limiting the present inventive concept. Thus, the expression of singularity in the present specification includes the expression of plurality unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

The present invention will now be described more fully with reference to the accompanying drawings, in which exemplary embodiments of the invention are shown. Throughout the drawings, like reference numerals denote like elements. In the following description, descriptions on the like elements will be omitted herein.

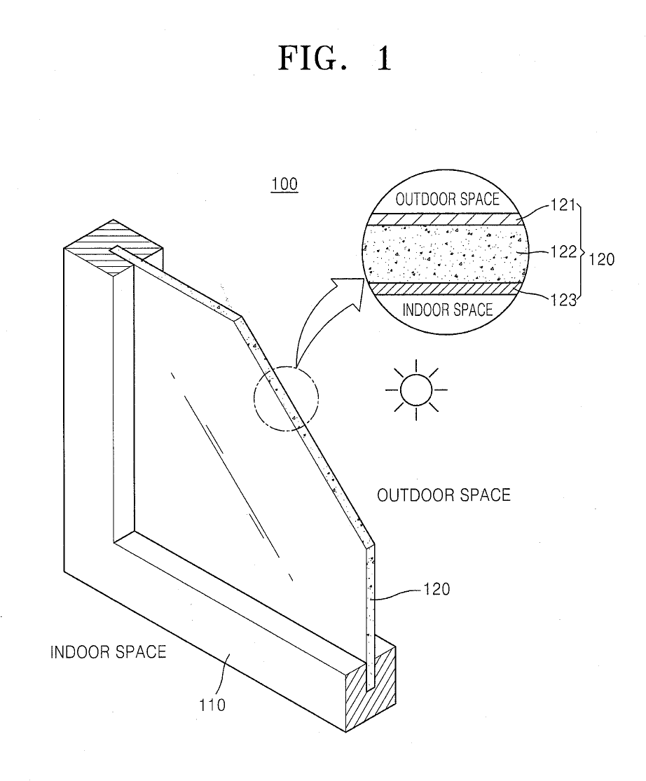

FIG. 1 illustrates a window 100 according to an embodiment of the present invention. Referring to FIG. 1, the window 100 according to the present embodiment includes a frame 110 and a panel 120. The window 100 may be installed on a building, a vehicle, and so forth and divides a building, for example, into an indoor space and an outdoor space. The frame 110 fixes the panel 120. The shape and structure of the frame 110 are not limited to those shown in FIG. 1, and a variety of suitable shapes and structures that are well known may be employed.

The panel 120 includes a transparent substrate 122, a thermochromic layer 121, and far infrared ray emitting layer 123. The transparent substrate 122 is formed of, for example, glass. Any suitable material may be selected, regardless of thickness, dimension, or shape thereof, as long as the material exhibits transparency and smoothness. In addition to glass, the transparent substrate 122 may be formed of indium tin oxide (ITO) or a film of a polymer such as polyester, polysulfone, polycarbonate, polyamide, polystyrene, polymethylpentane, polyethyleneterephthalate, and/or polyvinyl chloride.

The thermochromic layer 121 is a layer including a compound that undergoes metal insulator transition (MIT) at a phase transition temperature. The thermochromic layer 121 may include vanadium oxide, for example, vanadium dioxide VO₂ having a stoichiometric ratio of about 1:2 between vanadium atoms and oxygen atoms or vanadium pentoxide V₂O₅ having a stoichiometric ratio of about 2:5 between vanadium atoms and oxygen atoms. The vanadium oxide has a phase transition temperature of about 68° C. Accordingly, if a surrounding temperature is higher than about 68° C., the vanadium oxide is in a metallic state and blocks or reflects near infrared (NIR) rays. If the surrounding temperature is lower than about 68° C., the vanadium oxide is in a semiconductor state and transmits near infrared rays.

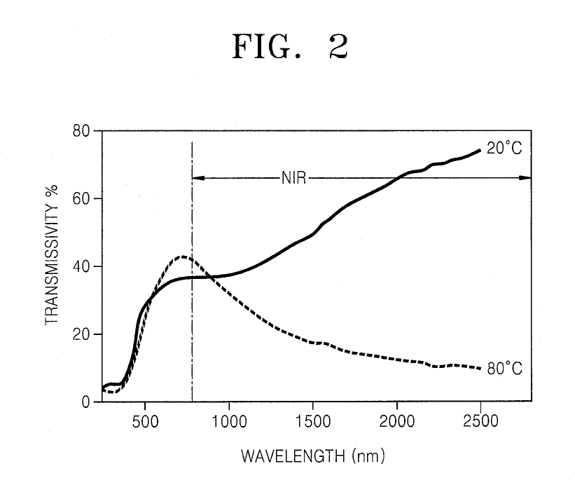

FIG. 2 is a graph showing an infrared ray transmissivity rate of vanadium oxide. In a wavelength range of about 780 nm to about 2500 nm (that is, in the near infrared region), if the surrounding temperature is about 80° C., which is higher than the phase transition temperature of vanadium oxide, the near infrared ray transmissivity rate of vanadium oxide decreases to about 20%. Also, if the surrounding temperature is about 20° C., which is lower than the phase transition temperature of vanadium oxide, the near infrared ray transmissivity rate of vanadium oxide increases to about 70%. Since the thermochromic layer 121 is used for a window, to change the phase transition temperature to a range of about 10° C. to about 30° C., vanadium oxide may include halogen atoms including fluorine (F) and/or metal atoms including titanium (Ti), niobium (Nb), molybdenum (Mo), iridium (Ir), and/or tungsten (W). In the present embodiment, the thermochromic layer 121 is deposited on the transparent substrate 122 to face the outside of a building, for example. The thermochromic layer 121 may be deposited to a thickness of several tens to hundreds of nanometers and, in one embodiment, is less than 500 nm to perform a thermochromic function without deteriorating the transmissivity of the panel 120. In one embodiment, when the thermochromic layer 121 is deposited to a thickness of over about 500 nm, the transmissivity of a visible ray range is lowered to be less than about 10%. The thermochromic layer 121 may be formed by a method such as chemical vapour deposition (CVD), sputtering, and/or coating.

The far infrared ray emitting layer 123 is a functional layer including a material that emits far infrared (FIR) rays by utilizing heat and light. In the present embodiment, the far infrared ray emitting layer 123 emits far infrared rays in proportion to the amount of the near infrared ray. For example, when the amount of near infrared rays incident on the far infrared ray emitting layer 123 is large, a large amount of far infrared rays is emitted. Also, when the amount of near infrared rays incident on the far infrared ray emitting layer 123 is small, a small amount of far infrared rays is emitted.

The far infrared ray emitting layer 123 according to the present embodiment includes a far infrared ray emitting material such as ceramic powder and/or an insulation material. The ceramic powder emits far infrared rays having a wavelength of about 4000 nm to about 25000 nm and has a spectral reflectance of about 60% to about 100%, and, in one embodiment of about 65%. For example, one or more materials selected from zirconium (Zr), phosphorus pentoxide (P₂O₅), alumina (Al₂O₃), silicon dioxide (SiO₂), titanium dioxide (TiO₂), ferric oxide (Fe₂O₃), germanium (Ge), nickel zinc (NiZn), calcium dioxide (CaO₂), magnesium oxide (MgO), potassium trioxide (K₂O₃), sodium dioxide (Na₂O), zirconium dioxide (ZrO2), selenium (Se), magnesium-zinc alloy (MgZn), manganese-zinc alloy (MnZn), strontium oxide (SrO₂), Calcium oxide (CaO), molybdenum oxide (MoO₃), cobalt oxide (CoO), cerium oxide (CeO2), and/or copper carbonate (CuCO₃) are used as the ceramic powder.

The insulation material is effective in insulation and heat regeneration by near infrared ray incident on the far infrared ray emitting layer 123. For example, one or more materials selected from dimethyl terephthalate, ethylene glycol, polytrimethylene terephthalate base, polycarbonate base, and/or polyurethane are used as the insulation material. In the present embodiment, the far infrared ray emitting layer 123 is deposited on the transparent substrate 122 to face the indoor space of a building, for example. The far infrared ray emitting layer 123 may be deposited to a thickness of several tens to hundreds of nanometers and, in one embodiment, is about 500 nm to perform far infrared rays emission function without deteriorating the transmissivity of the panel 120. In one embodiment, when the far infrared ray emitting layer 123 is deposited to a thickness of over about 500 nm, the transmissivity of a visible ray range is lowered to be less than about 10%.

The far infrared ray emitting layer 123 is formed by adding a far infrared ray emitting material to the insulation material and mixing the materials uniformly and then depositing a mixture on the transparent substrate 122 by sputtering and/or coating. The far infrared ray emitting material and the insulation material are mixed at about 10-30 wt % and at about 70-90 wt %, respectively. In one embodiment, when the quantity of the far infrared ray emitting material is less than about 10 wt %, the quantity of the far infrared ray emitting material is small so that insulation and heat regeneration effects due to the emission of far infrared rays is not realized. In another embodiment, when the quantity of the far infrared ray emitting material is greater than about 30 wt %, it is difficult to form the far infrared ray emitting layer 123 to a thickness of several tens to hundreds of nanometers due to difficulty in process.

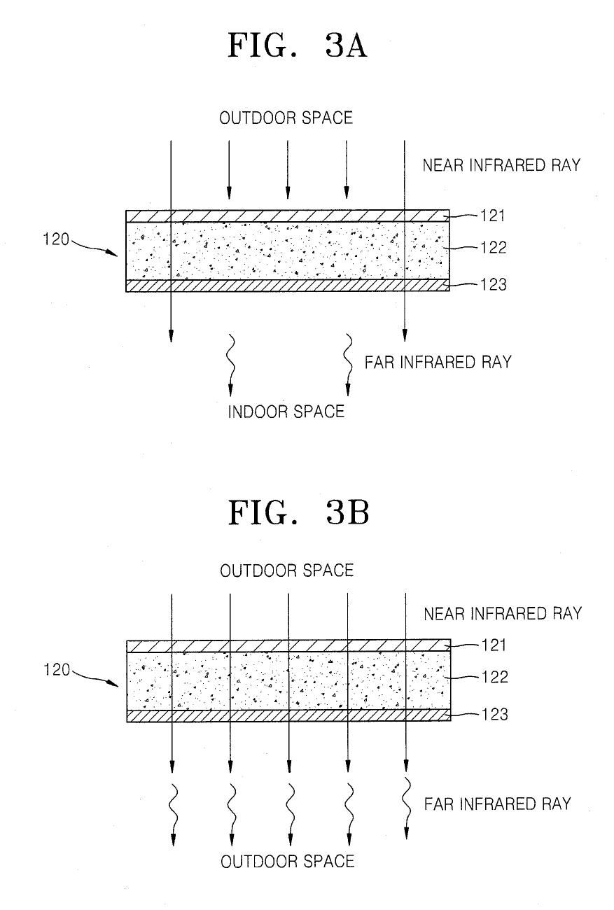

FIGS. 3A and 3B illustrate the operation of the panel 120 of FIG. 1. FIG. 3A illustrates a case in which an outdoor temperature is higher than a phase transition temperature of the thermochromic layer 121. In this case, the thermochromic layer 121 blocks and reflects near infrared rays entering the indoor space from the outdoor space. Since most of near infrared rays is blocked and reflected by the thermochromic layer 121, the far infrared ray emitting layer 123 receives a small quantity of near infrared rays. Thus, the far infrared ray emitting layer 123 emits a small quantity of far infrared rays.

Thus, in the summer season when it is hot outdoors, since the quantity of near infrared rays entering the indoor space is reduced by the thermochromic layer 121 and a small quantity of far infrared rays is emitted by the far infrared ray emitting layer 123, the indoor temperature is not raised too much by the external near infrared rays and the far infrared rays passing through the panel 120 so that a cool temperature may be maintained.

FIG. 3B illustrates a case in which an outdoor temperature is lower than a phase transition temperature of the thermochromic layer 121. In this case, the thermochromic layer 121 transmits near infrared rays entering the indoor space from the outdoor space. Since most of near infrared rays passes through the thermochromic layer 121, the far infrared ray emitting layer 123 receives a large quantity of near infrared rays. Thus, the far infrared ray emitting layer 123 emits a large quantity of far infrared rays.

Thus, in the winter season when it is cold outdoors, since a large quantity of near infrared rays enters the indoor space through the thermochromic layer 121 and a large quantity of far infrared rays is emitted by the far infrared ray emitting layer 123, the indoor temperature can be raised to a desired level by the external near infrared rays and the far infrared rays passing through the panel 120 so that heating costs may be saved.

In an embodiment of the present invention in which the thermochromic layer 121 is deposited to have a thickness of about 100 nm, when a surrounding temperature is higher than a phase transition temperature (a), for example, in the summer season, the transmissivity of near infrared rays of the thermochromic layer 121 is at an average of about 27.66%, and when a surrounding temperature is lower than a phase transition temperature (b), for example, in the winter season, the transmissivity of near infrared rays of the thermochromic layer 121 is at an average of about 60.15%. The following result may be obtained on an assumption that the spectral reflectance of the far infrared ray emitting layer 123 is about 65%. That is, in the case of (a), the far infrared ray emitting layer 123 emits far infrared rays at an average of about 17.98%, which corresponds to about 65% of the quantity of the near infrared ray incident on the far infrared ray emitting layer 123. In the case of (b), the far infrared ray emitting layer 123 emits far infrared rays at an average of about 39.10%, which corresponds to about 65% of the quantity of the near infrared rays incident on the far infrared ray emitting layer 123.

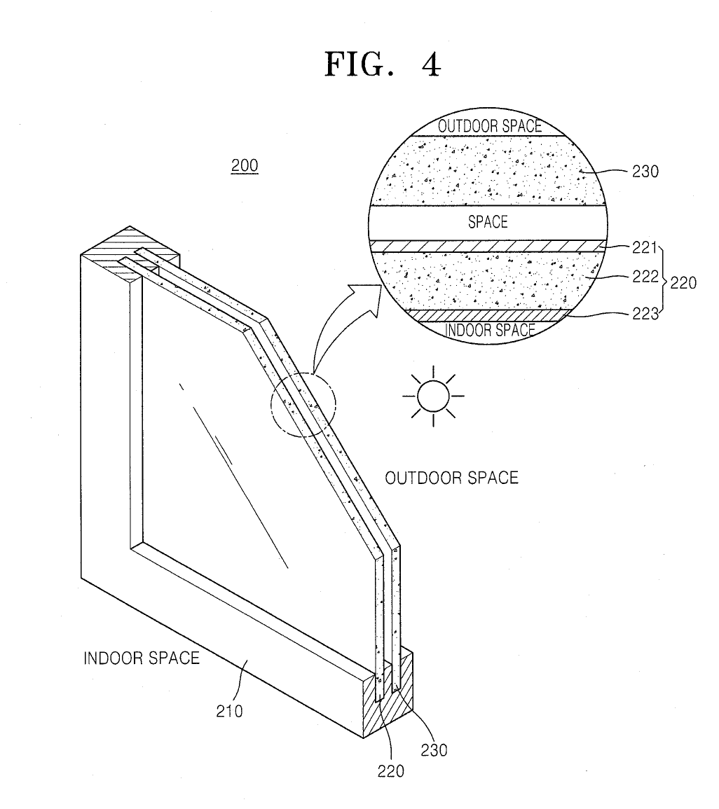

FIG. 4 illustrates a multiple-glazed window 200 according to an embodiment of the present invention. Referring to FIG. 4, the multiple-glazed window 200 according to the present embodiment includes a frame 210, a first panel 220, and a second panel 230. Although FIG. 4 illustrates a double-glazed window, the present invention is not limited thereto and may be applied not only to the double-glazed window but also to a triple-glazed window, a quadruple-glazed window, etc.

The multiple-glazed window 200 of FIG. 4 is different from the window 100 of FIG. 1 in that the second panel 230 formed of a transparent substrate is additionally included. Like the panel 120 of FIG. 1, the first panel 220 includes a first transparent substrate 222, a first far infrared ray emitting layer 223, and a first thermochromic layer 221. Since the constituent elements of the multiple-glazed window 200 of FIG. 4 correspond to those of the window 100 of FIG. 1, detailed descriptions thereon will be omitted herein.

Referring to FIG. 4, the first panel 220 includes the first far infrared ray emitting layer 223 arranged close to the indoor space, the first transparent substrate 222, and the first thermochromic layer 221 arranged close to the outdoor space. Also, a space is provided between the first thermochromic layer 221 and the second panel 230. The second panel 230 is formed of a transparent substrate and arranged closest to the outdoor space.

The second panel 230 is formed of, for example, glass, indium tin oxide (ITO), and/or a film of a polymer such as polyester, polysulfone, polycarbonate, polyamide, polystyrene, polymethylpentane, polyethyleneterephthalate, and/or polyvinyl chloride. The space exists between the second panel 230 and the first panel 220 and is in a vacuum state or filled with air and/or an inert gas such as argon (Ar).

Since the multiple-glazed window 200 of FIG. 4 includes the second panel 230 arranged closest to the outdoor, the multiple-glazed window 200 can protect the first thermochromic layer 221 from an external shock, in addition to the merits of heat retaining, insulation, and increased strength.

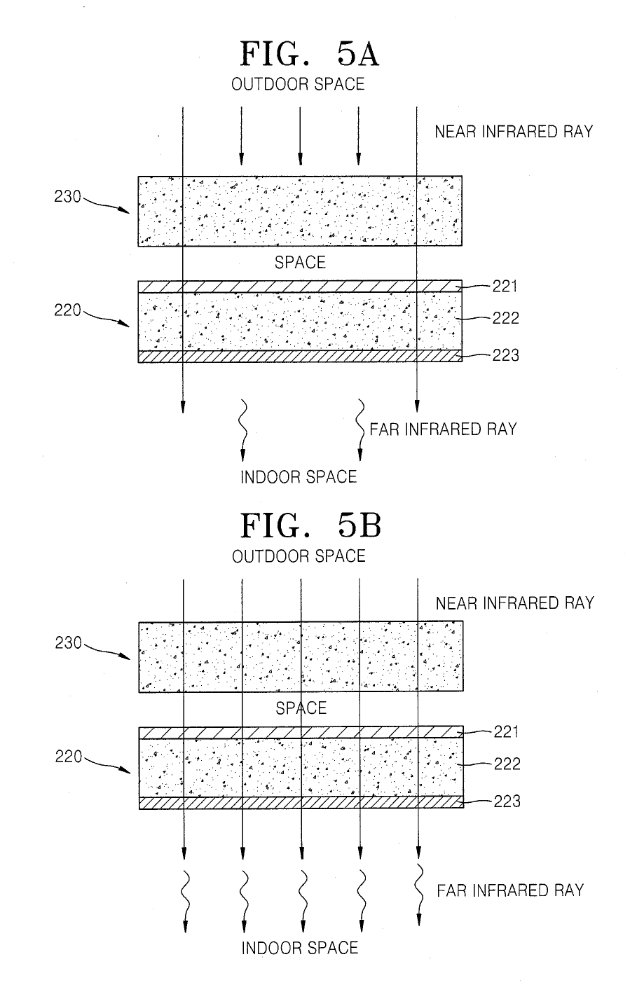

FIGS. 5A and 5B illustrate the operation of the first and second panels 220 and 230 of FIG. 4. Since the operations of the first and second panels 220 and 230 shown in FIGS. 5A and 5B are similar to or the same as those of the panel 120 of FIG. 1, detailed descriptions thereon will not be provided again herein, and only characteristics of the multiple-glazed window 200 are described below.

FIG. 5A illustrates a case in which an outdoor temperature is higher than a phase transition temperature of the first thermochromic layer 221. In this case, since most of the near infrared rays is blocked and reflected by the first thermochromic layer 221, a small quantity of near infrared rays is received by the first far infrared ray emitting layer 223. Thus, the first far infrared ray emitting layer 223 emits a small quantity of far infrared rays.

In the summer season when the outdoor temperature is high, since the quantity of near infrared rays entering the indoor space is reduced by the first thermochromic layer 221 and a small quantity of far infrared rays is emitted by the first far infrared ray emitting layer 223, the indoor temperature is not raised too much by the external near infrared rays and the far infrared rays passing through the first panel 220 so that a cool temperature may be maintained.

FIG. 5B illustrates a case in which an outdoor temperature is lower than a phase transition temperature of the first thermochromic layer 221. In this case, since most of near infrared rays passes through the first thermochromic layer 221, the first far infrared ray emitting layer 223 receives a large quantity of near infrared rays. Thus, the far infrared ray emitting layer 223 emits a large quantity of far infrared rays.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A window comprising a frame and a panel, the panel comprising:
a transparent substrate;
a far infrared ray emitting layer deposited on the transparent substrate; and
a thermochromic layer deposited on the transparent substrate and arranged to be closer than the far infrared ray emitting layer to an outdoor space.

2. The window of claim 1, wherein the thermochromic layer comprises vanadium oxide.

3. The window of claim 2, wherein the vanadium oxide has a stoichiometric ratio of about 1:2 or about 2:5 between vanadium atoms and oxygen atoms.

4. The window of claim 2, wherein the thermochromic layer comprises a material selected from the group consisting of fluorine (F), titanium (Ti), niobium (Nb), molybdenum (Mo), iridium (Ir), and tungsten (W).

5. The window of claim 1, wherein the far infrared ray emitting layer comprises a far infrared ray emitting material and an insulation material.

6. The window of claim 5, wherein the far infrared ray emitting layer comprises the far infrared ray emitting material and the insulation material at 10-30 wt % and 70-90 wt %, respectively.

7. The window of claim 5, wherein the far infrared ray emitting material comprises ceramic powder.

8. The window of claim 5, wherein the insulation material comprises a material selected from the group consisting of dimethyl terephthalate, ethylene glycol, polytrimethylene terephthalate base, polycarbonate base, and polyurethane.

9. The window of claim 1, wherein the far infrared ray emitting layer is arranged to be closer than the thermochromic layer to an indoor space.

10. The window of claim 1, wherein the far infrared ray emitting layer is configured to emit far infrared rays in proportion to the quantity of near infrared rays passing through the thermochromic layer.

11. A multiple-glazed window comprising a frame, a first panel, and a second panel, the first panel comprising:
a first transparent substrate;
a far infrared ray emitting layer deposited on the first transparent substrate; and
a thermochromic layer deposited on the first transparent substrate and arranged to be closer than the far infrared ray emitting layer to an outdoor space,
wherein the second panel comprises a second transparent substrate.

12. The multiple-glazed window of claim 11, wherein the thermochromic layer comprises vanadium oxide.

13. The multiple-glazed window of claim 12, wherein the vanadium oxide has a stoichiometric ratio of about 1:2 or about 2:5 between vanadium atoms and oxygen atoms.

14. The multiple-glazed window of claim 12, wherein the thermochromic layer comprises a material selected from the group consisting of fluorine (F), titanium (Ti), niobium (Nb), molybdenum (Mo), iridium (Ir), and tungsten (W).

15. The multiple-glazed window of claim 11, wherein the far infrared ray emitting layer comprises a far infrared ray emitting material and an insulation material.

16. The multiple-glazed window of claim 15, wherein the far infrared ray emitting layer comprises the far infrared ray emitting material and the insulation material at 10-30 wt % and 70-90 wt %, respectively.

17. The multiple-glazed window of claim 15, wherein the far infrared ray emitting material comprises ceramic powder.

18. The multiple-glazed window of claim 15, wherein the insulation material comprises a material selected from the group consisting of dimethyl terephthalate, ethylene glycol, polytrimethylene terephthalate base, polycarbonate base, and polyurethane.

19. The multiple-glazed window of claim 11, wherein the far infrared ray emitting layer is arranged to be closer than the thermochromic layer to an indoor space.

20. The multiple-glazed window of claim 11, wherein the second panel is arranged to be closer than the thermochromic layer to the outdoor space and a space is provided between the first panel and the second panel.

21. The multiple-glazed window of claim 11, wherein the far infrared ray emitting layer is configured to emit far infrared rays in proportion to the quantity of near infrared rays passing through the thermochromic layer.
